(19) United States
(12) Patent Application Publication
(10) Pub. No.: US 2010/0079416 A1
(43) Pub. Date: Apr. 1, 2010

(54) Radio frequency identification (RFID), display pixel, and display panel and display apparatus using RFID display pixel

(75) Inventors: Deuk-seok Chung, Yongin-si (KR); Jung-woo Kim, Yongin-si (KR); Yong-wan Jin, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/453,190

(22) Filed: May 1, 2009

(30) Foreign Application Priority Data
Sep. 29, 2008 (KR) 10-2008-0095544

(51) Int. Cl. G06F 3/038; H04Q 5/22

(52) U.S. Cl. 345/204; 340/10.51

(57) ABSTRACT

Example embodiments include an RFID display pixel, and a display panel and a display apparatus using the RFID display pixel. The RFID display pixel includes an RFID tag having an antenna and an IC chip; and a display device connected to the RFID tag. The display device is driven according to information received from the antenna. The display apparatus includes a display panel having a two-dimensional array of a plurality of RFID display pixels having the RFID tag and display device. An image control unit generates an image signal to be displayed on the display panel and an RFID reading unit wirelessly communicates with the RFID tag and transmits the image signal generated in the image control unit to the RFID tag.

### PRIORITY STATEMENT

This application claims priority under U.S.C. §119 to Korean Patent Application No. 10-2008-0095544, filed on Sep. 29, 2008, in the Korean Intellectual Property Office, the entire contents of which are incorporated herein in by reference.

### BACKGROUND

1. Field

Example embodiments are directed to a radio frequency identification (RFID) display pixel, and a display panel and a display apparatus using the RFID pixel.

2. Description of the Related Art

Radio frequency identification (RFID) technology refers to recognition technology using radio frequency (MHz-GHz) including audio frequency, which identifies objects without physically contacting the objects. As the frequency band is relatively broad, various types of frequencies can be used according to the filed of application.

An RFID system using RFID technology can be used to acquire information of product(s) in a wireless manner. The RFID system may include an RFID tag (transponder) containing information about the product(s), and may be attached to the product(s) and an RFID reader (interrogator) which may extract the information on the product(s) by wirelessly communicating with the RFID tag.

The RFID tag may include an antenna and an RFID chip, and information transmitted from the RFID reader may be stored and/or renewed in the RFID chip. The information stored in the RFID chip may be transmitted to the RFID reader via the antenna. The RFID tag may modulate a wireless signal transmitted from an antenna of the RFID reader based on the information stored in the RFID chip, and may reflect the wireless signal to the RFID reader. The RFID reader may read information stored in the RFID chip from the modulated and reflected wireless signal.

Example embodiments may integrate display technology with the RFID system. For example, an RFID tag and a display system may be connected to each other such that information about a product(s) received from the RFID tag may be displayed.

### SUMMARY

Example embodiments are directed to a radio frequency identification (RFID) display pixel, and a display panel and a display apparatus using the RFID display pixel.

According to example embodiments, a radio frequency identification (RFID) display pixel may include: an RFID tag having an antenna and an integrated circuit (IC) chip; and a display device connected to the RFID tag and driven based on at least a part of information received from the antenna.

The display device may be a reflective display device or a bistable reflective display device.

Additionally, the display device may be an electrophoretic display device, an electrochromic display device and/or a cholesteric liquid crystal display (LCD) device.

According to example embodiments, a display panel may include a two-dimensional (2D) array of a plurality of RFID display pixels, wherein at least one of the RFID display pixels may have an RFID tag and a display device. The RFID tag may have an antenna and an IC chip, and the display device may be connected to the RFID tag. The display device may be driven based on at least a part of an information received from the antenna.

According to some example embodiments, the display device of the display panel may be a reflective display device or a bistable reflective display device.

Additionally, the display device may also be an electrophoretic display device, an electrochromic display device, and/or a cholesteric liquid crystal display (LCD) device.

According to example embodiments, an identifier identifying the RFID display pixel may be stored in the IC chip of the RFID tag.

According to example embodiments, a display apparatus may include: a display panel having a two-dimensional (2D) array of a plurality of RFID display pixels. At least one of the plurality of RFID display pixels may include an RFID tag and a display device. The RFID tag may have an antenna and an IC chip, and the display device may be formed on the RFID tag. The display device may be driven according to information received from the antenna. The display apparatus may further include an image control unit that may generate an image signal to display on the display panel and an RFID reading unit that may wirelessly communicate with the RFID tag and may transmit the image signal generated in the image control unit to the RFID tag.

According to some example embodiments, the display device of the display apparatus may be a reflective display device or a bistable reflective display device.

Additionally, the display device may also be an electrophoretic display device, an electrochromic display device, and/or a cholesteric liquid crystal display (LCD) device

An identifier identifying the RFID display pixel may be stored in the IC chip of the RFID tag.

According to example embodiments, the RFID reading unit may transmit information for driving the plurality of RFID display pixels in a sequential order of identifiers.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 illustrates the configuration and operation of a radio frequency identification (RFID) display pixel according to an example embodiment;

FIGS. 2A and 2B are example cross-sectional views illustrating the RFID display pixel of FIG. 1 in a driving mode;

FIG. 3 illustrates a plan view of an RFID tag applied to the RFID display pixel according to an example embodiment;

FIG. 4 illustrates a display panel according to an example embodiment; and

FIG. 5 illustrates a display apparatus according to an example embodiment.

### DETAILED DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

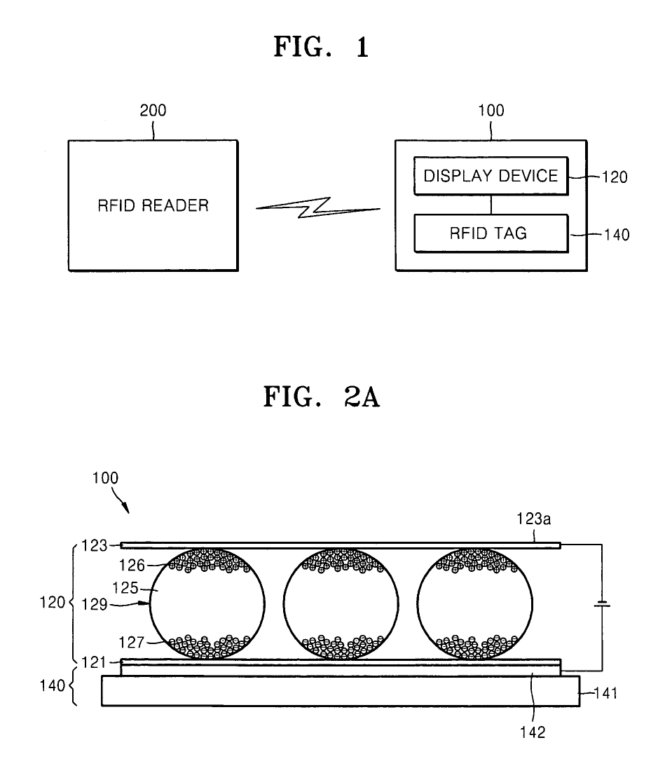

FIG. 1 illustrates a configuration and operation of a radio frequency identification (RFID) display pixel 100 according to example embodiments.

Referring to FIG. 1, the RFID display pixel 100 may include a display device 120 and an RFID tag 140. The RFID tag 140 may include an integrated circuit chip and an antenna, and the display device 120 may be driven according to information received from the antenna. Information may be stored in the RFID tag 140, and the stored information may be transmitted or renewed by wireless communication between an RFID reader 200 and the RFID tag 140. The wireless communication between the RFID reader 200 and the RFID tag 140 may be conducted by using electromagnetic wave, for example. According to example embodiments, the RFID reader 200 may transmit a known voltage and/or current signal(s) to the RFID tag 140. The display device 120 may be designed to receive necessary voltage and/or currents required to drive the display device 120 from the RFID tag 140. The display device 120 may be a reflective device which may be operated in a mode in which externally received light is reflected, or the display device 120 may be a bistable reflective device which may be driven at low power. Examples of the display device 120 may include an electrophoretic display device, an electrochromic device, and a cholesteric liquid crystal device, or the like.

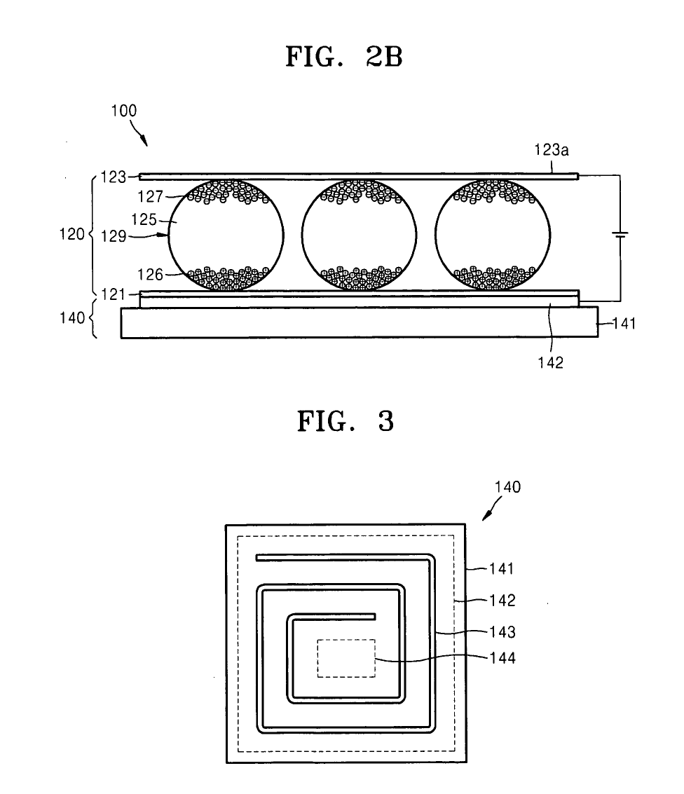

FIGS. 2A and 2B are example cross-sectional views illustrating the RFID display pixel 100 of FIG. 1, in a driving mode, for example. FIG. 3 illustrates a plan view of an RFID tag 140 of the RFID display pixel 100 according to an example embodiment.

Referring to FIGS. 2A, 2B, and 3, the RFID display pixel 100 may include the RFID tag 140 and the display device 120 disposed on the RFID tag 140. A tag electrode 142 may be formed on a base film 141 of the RFID tag 140, and the display device 120 may be formed on the tag electrode 142.

Also, an antenna 143 and an IC chip 144 may be further formed on the base film 141 of the RFID tag 140, in addition to the tag electrode 142. The antenna 143 may receive information transmitted from an external RFID reader, and may be, for example, in a form of a loop surrounding inner portions of the base film 141 as shown in FIG. 3. However, this is exemplary. A cover film (not shown) may be formed over the antenna 143, or the antenna 143 may be formed on a side of the base film 141 opposite to the side where the tag electrode 142 is formed. For example, identification information of the RFID display pixel 100 may be stored in the IC chip 144, and other elements such as a circuit for supplying a voltage between the electrodes 121 and 123 and a circuit generating driving voltage and/or currents from an electromagnetic wave received by the antenna 143 may be included in the IC chip 144. The IC chip 144 may be included in the base film 141, and may be electrically connected to the tag electrode 142 and/or the antenna 143 by using a connection unit (not shown).

It will be well appreciated by the person skilled in the art that a variety of display devices may be used as the display device 120. However, for the sake of explaining the working of the example embodiments, the display device 120 is assumed to be an electrophoretic display device driven by electrophoresis of charged particles. Accordingly, the display device 120 may also be referred to as an electrophoretic display device 120 in the subsequent discussion. The electrophoretic display device 120 may include micro capsules 129 containing micro particles 126 and 127 of different colors and oppositely charges are dispersed in a dispersion medium 125. The micro capsules 129 may be disposed between two electrodes 121 and 123. The charged micro particles 126 and 127 may be attracted according to a voltage applied between the two electrodes 121 and 123. The dispersion medium 125 may be formed, for example, of a transparent fluid and the colors of the micro particles 126 and 127 may be displayed on a display surface 123a.

As shown in FIG. 2A, positively-charged micro particles 126 are attracted to the electrode 123, and negatively-charged micro particles 127 are attracted to the electrode 121. In such a case, the color of the positively-charged micro particles 126 may be displayed on the display surface 123a. As illustrated in FIG. 2B, positively-charged micro particles 126 are attracted to the electrode 121, and negatively-charged micro particles 127 are attracted to the electrode 123, and the color of the negatively-charged micro particles 127 may be displayed on the display surface 123a.

The electrophoretic display device 120 may be bistable, and therefore even after the electric field is removed, the micro particles 126 and 127 do not disperse in the dispersion medium 125. Accordingly, once the color is displayed on the display surface 123a, no power supply is necessary for maintaining the displayed color, thereby reducing the power consumption.

The above-described RFID display pixel 100 may be a basic unit of a display device in which one pixel is realized using one RFID tag 140. However, a plurality of pixels may also be realized using a single RFID tag 140. Accordingly, in such a situation, a plurality of the tag electrodes 142 may be formed and an electric field may be applied individually to each tag electrode 142. However, example embodiments are not limited thereto and a variety of configurations are possible, as will be apparent to a person of ordinary skills in the art.

Also, example embodiments of the electrophoretic display device 120 described above are not limited thereto and other structures may also be possible. For example, the electrophoretic display device 120 may have a structure in which one type of micro particles are dispersed in a colored fluid, wherein the color of the micro particles and/or the color of the fluid may be displayed on the display surface based on the applied electric field. Also, other than an electrophoretic display device, a bistable reflective display device such as an electrochromic display device or a cholesteric liquid crystal display (LCD) device may also be used.

FIG. 4 is a schematic view of a display panel 400 according to an embodiment. The display panel 400 includes a plurality of RFID display pixels 100 arranged in a two-dimensional (2D) array. The RFID display pixels 100 are respectively formed of an RFID tag that includes an antenna and an IC chip. A display device is formed on the RFID tag and is driven according to information received from the antenna, as illustrated in FIGS. 2A, 2B, and 3. Numbers, for example, may be included in the IC chips of the RFID display pixels 100 as identifiers (ID) for classifying each of the RFID display pixels 100. As mentioned above, the RFID display pixels 100 use externally transmitted information as a voltage and/or current source, and do not require wiring for supplying external power to each of the pixels forming the display panel 400. For example, the display panel 400 may be formed by arranging the RFID display pixels 100 in the form of tiles on a substrate 410, and the size of a screen may be designed with less restriction and a large-sized screen display may be realized with relative case.

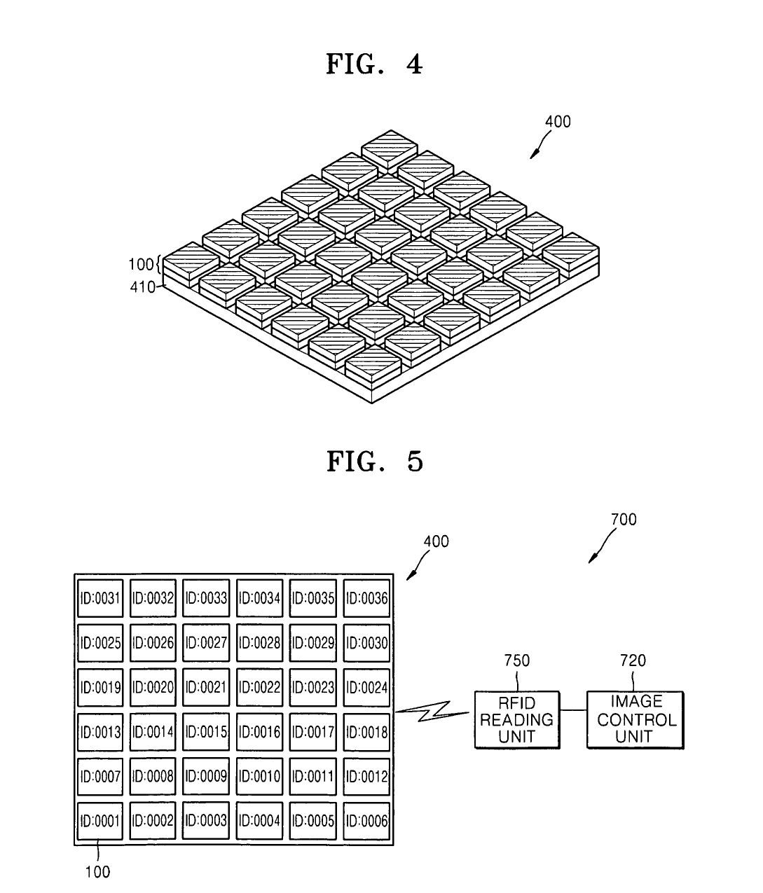

FIG. 5 illustrates a display apparatus 700 according to an example embodiment.

Referring to FIG. 5, the display apparatus 700 may include a display panel 400, an image control unit 720, and an RFID reading unit 750. The display panel 400 may include a plurality of RFID display pixels 100. According to example embodiment described above. The image control unit 720 may generate an image signal to display an image on the display panel 400.

The RFID reading unit 750 may communicate with the RFID tag of the RFID display pixel 100 in a wireless fashion and may transmit the image signal generated from the image control unit 720 to the RFID display pixel 100. An identifier that identifies an RFID display pixel 100 may be stored in an IC chip of the RFID display pixel 100. The RFID reading unit 750 may transmit information that drives the RFID display pixels 100. This information may be transmitted in multiple channels and may include the image signal generated in the image control unit 720 for the RFID pixels 100 along with the voltage and/or current signals. The RFID reading unit 750 may transmit the information for driving the RFID display pixels 100 in an sequential order of identifiers. For example, if numerals are used as identifiers, the RFID reading unit 750 may transmit the information for driving the RFID display pixels 100 in a sequential order of numerals.

The RFID tag of the RFID display pixels 100 may supply a voltage to the display device according to information on the corresponding ID. The display device may be driven based on to the supplied voltage, according to the example embodiment described above with reference to FIGS. 2A and 2B. An image display may be realized by the combination of colors displayed on the display surfaces of the RFID display pixels 100.

The display apparatus 700 may not require a wire structure for supplying external power to each of the pixels and may thus have a relatively simple structure and the screen size thereof may be designed with relatively less restrictions. Also, a display device displaying colors using bistable particles may be used in the display apparatus 700, and therefore the display apparatus 700 may be driven with low power. The display apparatus 700 according to example embodiments may serve a variety of applications, such as outdoor advertisement, a wall display, an art wall, and the like.

The RFID tag of the RFID display pixel may have, according to example embodiments described above, no wiring and no power source, and may be driven by current and/or voltage data received in a wirelessly.

A large-sized screen display panel may be realized using the RFID display pixels according to example embodiment disclosed above.

The display apparatus according to example embodiments may have relatively better visibility and relatively low power consumption, and may remotely control images that are displayed on a screen in real-time using wireless communication.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A radio frequency identification (RFID) display pixel comprising:
an RFID tag including an antenna and an integrated circuit (IC) chip; and
a display device connected to the RFID tag and driven based on at least a part of an information received from the antenna.

2. The RFID display pixel of claim 1, wherein the display device is a reflective display device.

3. The RFID display pixel of claim 1, wherein the display device is a bistable reflective display device.

4. The RFID display pixel of claim 1, wherein the display device is at least one of an electrophoretic display device, an electrochromic display device, and a cholesteric liquid crystal display (LCD) device.

5. A display panel comprising a two-dimensional (2D) array of a plurality of RFID display pixels, at least one of the RFID display pixels including an RFID tag and a display device,
wherein the RFID tag includes an antenna and an IC chip, and the display device is connected to the RFID tag and is driven based on at least a part of an information received from the antenna.

6. The display panel of claim 5, wherein the display device is a reflective display device.

7. The display panel of claim 5, wherein the display device is a bistable reflective display device.

8. The display panel of claim 5, wherein the display device is at least one of an electrophoretic display device, an electrochromic display device, and a cholesteric LCD device.

9. The display panel of claim 5, wherein an identifier identifying the corresponding RFID display pixel is stored in the IC chip of the RFID tag.

10. A display apparatus comprising:
a display panel including a two-dimensional (2D) array of a plurality of RFID display pixels, at least one of the plurality of RFID display pixels including an RFID tag and a display device,
wherein the RFID tag includes an antenna and an IC chip, and the display device is connected to the RFID tag and is driven based on at least a part of an information received from the antenna;
an image control unit generating an image signal for display on the display panel; and
an RFID reading unit wirelessly communicating with at least one of the RFID display pixels and transmitting the image signal generated in the image control unit to the at least one of the RFID display pixels.

11. The display apparatus of claim 10, wherein the display device is a reflective display device.

12. The display apparatus of claim 10, wherein the display device is a bistable reflective display device.

13. The display apparatus of claim 10, wherein the display device is at least one of an electrophoretic display device, an electrochromic display device, and a cholesteric LCD device.

14. The display apparatus of claim 10, wherein an identifier identifying an RFID display pixel is stored in the IC chip of the RFID tag.

15. The display apparatus of claim 14, wherein the RFID reading unit transmits information for driving the RFID display pixel on multiple channels.

16. The display apparatus of claim 14, wherein the RFID reading unit transmits information for driving the plurality of RFID display pixels in a sequential order of identifiers.
